(19) United States
(12) Patent Application Publication
(10) Pub. No.: US 2013/0260667 A1
(43) Pub. Date: Oct. 3, 2013

(54) Vent Cover for a Forced Air Vent Plate

(71) Applicants: Joseph Francis Agri, SR., Derry, NH (US); Joseph Francis Agri, JR., Everett, MA (US)

(72) Inventors: Joseph Francis Agri, SR., Derry, NH (US); Joseph Francis Agri, JR., Everett, MA (US)

(21) Appl. No.: 13/432,917

(22) Filed: Mar. 28, 2012

(51) Int. Cl. F24F 7/00; B23P 19/04

(52) U.S. Cl. 454/254; 29/428

(57) ABSTRACT

A method and system for inhibiting the flow of air through a vent or vent plate within a living space. The present system includes a cover and side walls of a vent cover that are formed in the shape of the vent plate. Attached to the vent cover are magnets that are positioned on the vent cover to align with fasteners of the vent plate. The alignment of the magnets with the fasteners enables the vent cover to be securely attached to the vent plate via and prevent the flow of air from the living space.

### BACKGROUND OF THE INVENTION

There are many different heating, ventilation and air condition (HVAC) systems available to consumers. One common type of HVAC system is the forced air system. Forced air systems are used to supply hot air from a furnace and/or cold air from an air conditioning system to control the temperature within a living space.

The temperature of the living space is typically detected by a thermostat. In many installations, buildings are divided into multiple heating/cooling zones and the different heating/cooling zones are independently controlled by different the thermostats. This enables different parts of the home (or building) to be kept at different temperatures.

Forced air systems typically distribute the air through a network of ducts (or ductwork) to vents to supply the hot or cold air throughout the living space. A typical home HVAC system often has at least one vent in each room of the living space. Additionally, there are often one or two return air vents per floor of the home. However, depending on the size of the building, there could be greater or fewer room vents and return air vents.

The ductwork of the HVAC system is often routed through unconditioned space, such as an attic of the building. Thus, the ductwork is often exposed to colder temperatures in winter months (or hotter temperatures in summer months) than the rest of the living space. Routing the ductwork through the unconditioned attic increases the surface area through which heat (or cold) is lost from the living space.

Additionally, in some installations, blower units including evaporator coils and/or heat exchangers are also located in unconditioned space. Locating components of the HVAC system in the unconditioned attic space can further increase the amount of heat/cold loss of the living space.

Generally, the ductwork of the HVAC system terminates at the vents within the living space. Most vents typically include vent plates with louvers to diffuse the air throughout the room and/or living space. The vent plates are typically made from plastic or aluminum. The louvers of the vent plate are often adjusted by a lever, wheel, or remote. This way a person can open and close the louvers and control the amount of air that is able to pass through the vent plate and into or from the living space.

### SUMMARY OF THE INVENTION

Despite vent plates having louvers to control the flow of air, the vent plates are unable to completely stop the flow of air. Even when the louvers are completely closed, a significant amount of air is still able to flow through the louvers and vent plates. Thus, during the months when HVAC is not used to provide air to the living space, the heated or cooled air is immediately able escape from living space via vents and into the ductwork, which may be exposed to the cold or heat of the unconditioned space through which the ductwork extends. This leads to the loss of hot or cold air from the living space.

The present system is directed to a vent cover that inhibits the flow of air through the vents and/or vent plates of a living space and is especially useful for vent plates manufactured from inexpensive, non-ferromagnetic materials such as plastic or aluminum. The present system includes a vent cover, possibly with insulating side walls, that is formed in the shape of the vent plate. Typically, the vent cover is made from an insulating material such as polystyrene foam. Additionally, at least two discrete magnets are attached to the vent cover and when positioned on the vent plate will align with fasteners of the vent plate. The fasteners, such as screws, are almost universally made from iron or iron alloys, which are ferromagnetic. This enables the vent cover to be securely attached to the vent plate via the magnets and prevent the flow of air, even when the vent plate itself is non-ferromagnetic. Additionally, the vent cover can also be removed with no modifications required to the existing vents and/or vent plates.

In general, according to one aspect, the invention features a vent cover for a forced air vent plate for a building. The vent cover includes a cover for inhibiting air flow through the vent, and at least two discrete magnets that are positioned on the cover to align to fasteners of the vent plate.

In general, according to another aspect, the invention features a method for inhibiting the flow of air through a vent plate. The method includes providing a cover for inhibiting air flow through the vent plate, positioning at least two discrete magnets on the cover to align with fasteners of the vent plate, and securing the cover to the fasteners of the vent plate via the at least two discrete magnets.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view showing a distal side view of the vent cover.

FIG. 2 is a perspective view showing a proximal side of the vent cover.

FIG. 3 is a perspective view showing how the magnets of the vent cover align with the fasteners of a vent plate.

FIG. 4 is a perspective view showing the vent cover attached to the vent plate of the vent.

### DETAILED DESCRIPTION OF THE PREFERRED EMBODIMENTS

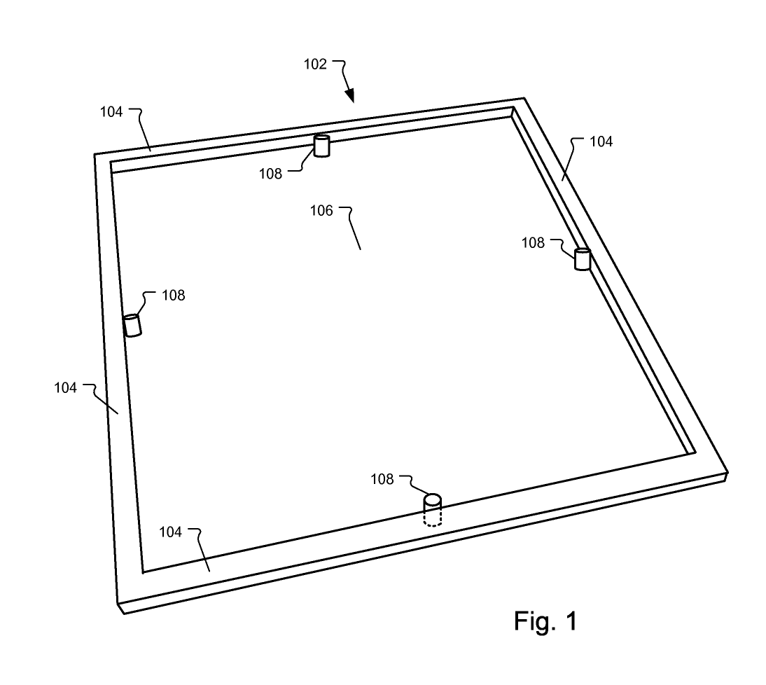

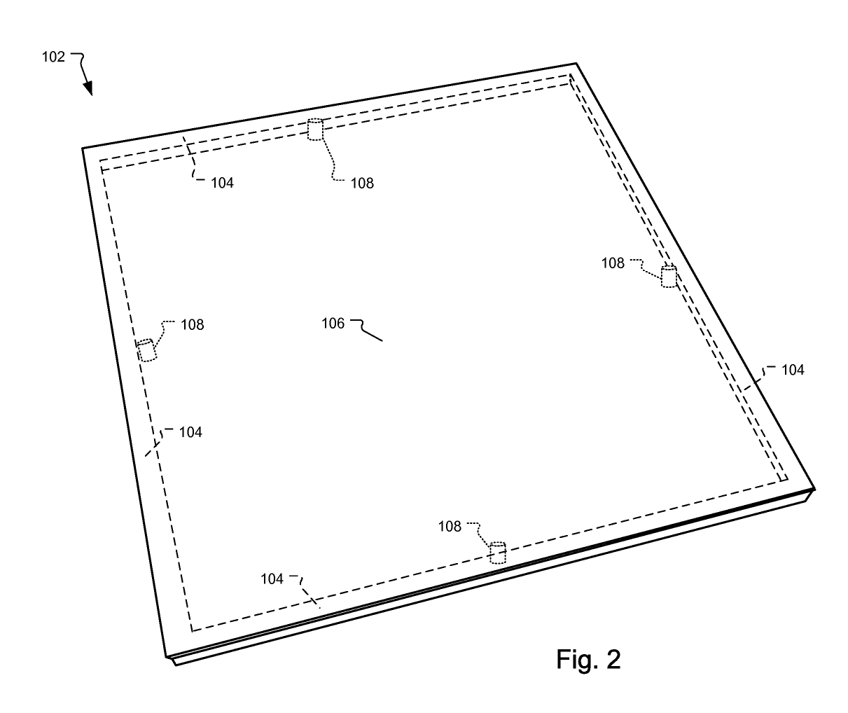

FIGS. 1 and 2 are perspective views illustrating the distal side and the proximal side, respectively, of the vent cover 102.

The vent cover 102 includes a cover 106 that inhibits the flow of air. In a typical implementation, the vent cover 102 includes insulating side walls 104 that are formed (or attached) around the perimeter of the distal side of the vent cover 102.

Generally, the cover 106 of the vent cover 102 has a planar surface and is constructed from a semi-rigid material that does not allow air to pass through it and is also preferably a good thermal insulator. In a preferred embodiment, the cover is made from extruded polystyrene foam.

In one embodiment, the insulating side walls 104 and the cover 106 are formed from a single piece of shaped polystyrene foam. In other embodiments, the insulating side walls 104 and the cover 106 are constructed from multiple pieces of material. In alternative embodiments, the cover 106 and insulating side walls 104 could also be made from other materials such as other foamed plastics, rubbers or solid plastics, to list a few examples.

The perimeter side walls 104 are typically manufactured from a more compliant plastic foam material so that it forms an air-tight seal against the surface of the vent plate.

Positioned around the interior of the insulating side walls 104 are discrete magnets 108. In a preferred embodiment, the magnets are permanent rare earth, such as neodymium magnets which are affixed, such as with glued, to the distal side of the cover 106. However, in alternative embodiments, other magnets could also be used. In some examples, the magnets 108 are molded into the insulating side walls 104 of the vent cover 102.

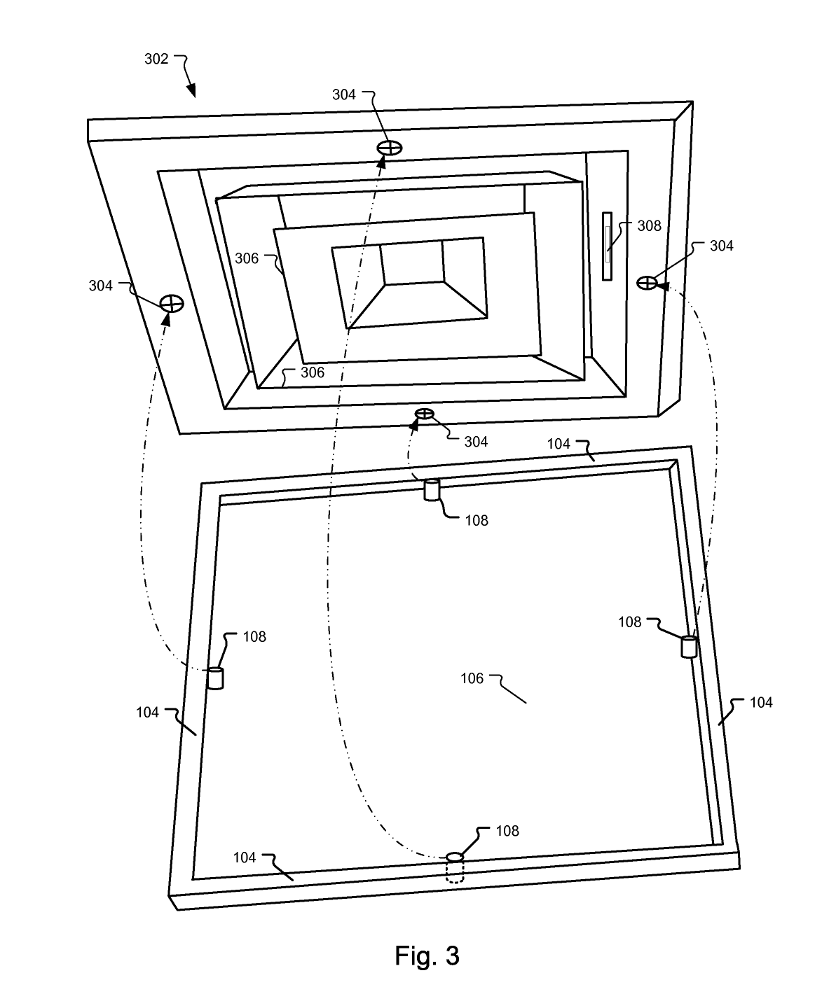

FIG. 3 is a perspective view showing how the magnets 108 of the vent cover 102 align to fasteners 304 of a vent plate 302.

Typically, the vent plates 302 are fabricated from inexpensive non-ferromagnetic materials. Generally, the vent plates 302 include functional or decorative louvers 306 that are designed to diffuse the air throughout the living space. The louvers 306 are often controlled by a lever control 308, rotating wheel, or remote control. The lever control 308 enables a person to open or close the louvers 306 and adjust the amount of air flowing from the vent into the living space.

Generally, the vent plates 302 are secured over the vent via fasteners 304, which are typically fabricated from ferromagnetic iron alloys. Typically, these fasteners 304 are small screws made from ferromagnetic materials (e.g. steel). In a typical implementation, the positioning of the magnets 108 on the cover 106 corresponds to the location of the fasteners 304 of the vent plates 302.

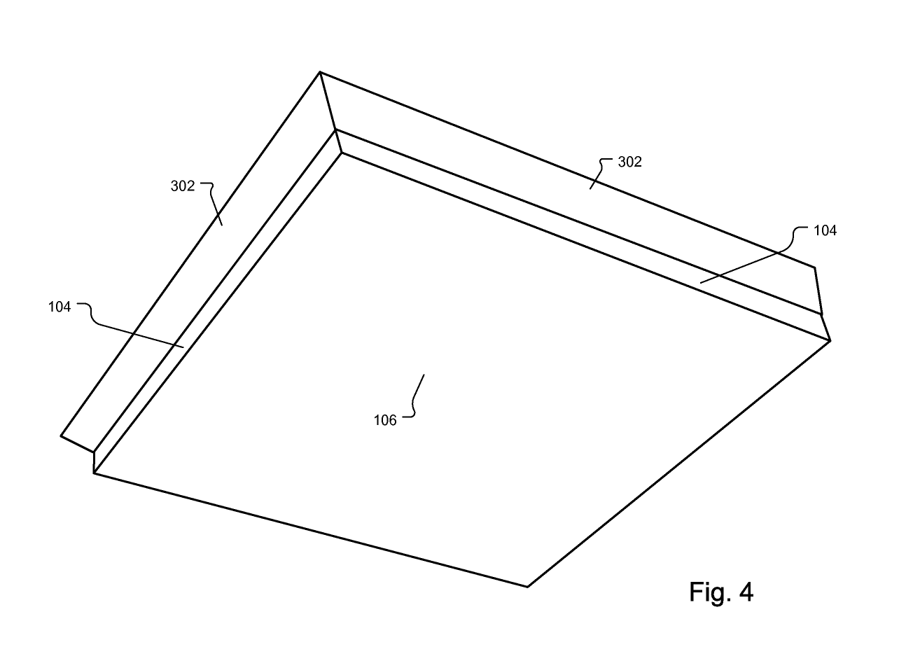

FIG. 4 is a perspective view that shows the proximal side of the vent cover 102 attached to the vent plate 302 of the vent.

In operation, the vent cover 102 and specifically the insulating side walls 104 create an air-tight seal between the vent cover and vent plate 302. However, because the vent cover 102 is secured to the vent plate 302 with magnets, it can easily be installed or removed without having to modify any of the preexisting vents or vent plates.

While the figures only illustrate a single example of one vent plate 302, there are numerous other vent plates in various shapes and sizes. One of ordinary skill will recognize that the size and shape of the cover 106 and insulating side walls 104 of the vent cover 102 can easily be adapted to correspond to different sized vent plates. Likewise, the size, strength, and position of the magnets 108 can also be modified to correspond to different locations and/or number of the fasteners of the vent plates.

In a further example, the discrete magnets 108 are not necessarily affixed to the cover 106 but are instead located on the proximal side of the cover and are held in place by the magnetic attraction to the fasteners 304.

While this invention has been particularly shown and described with references to preferred embodiments thereof, it will be understood by those skilled in the art that various changes in form and details may be made therein without departing from the scope of the invention encompassed by the appended claims.

What is claimed is:

1. A vent cover for a forced air vent plate for a building, the vent cover comprising:
a cover for inhibiting air flow through the vent; and
at least two discrete magnets that are positioned on the cover to align to fasteners of the vent plate.

2. The vent cover of claim 1, wherein the cover is a planar surface.

3. The vent cover of claim 2, wherein the cover is constructed from extruded polystyrene foam.

4. The vent cover of claim 1, wherein the cover is constructed from rubber.

5. The vent cover of claim 1, wherein the cover is constructed from plastic.

6. The vent cover of claim 1, wherein the at least two discrete magnets are neodymium magnets.

7. The vent cover of claim 1, wherein the at least two discrete magnets are rare earth magnets.

8. A method for inhibiting the flow of air through a vent cover of a vent plate, the method comprising:
providing a cover sized to the vent plate;
positioning at least two discrete magnets on the cover to align with fasteners of the vent plate; and
securing the cover to the fasteners of the vent plate via the at least two discrete magnets.

9. The method of claim 8, wherein the cover is a planar surface.

10. The method of claim 9, wherein the cover is constructed from foamed plastic.

11. The method of claim 8, wherein the cover is constructed from rubber.

12. The method of claim 8, wherein the cover is constructed from solid plastic.

13. The method of claim 8, wherein the at least two discrete magnets are neodymium magnets.

14. The method of claim 8, wherein the at least two discrete magnets are rare earth magnets.
